(19) United States
(12) Patent Application Publication
(10) Pub. No.: US 2007/0027620 A1
(43) Pub. Date: Feb. 1, 2007

(54) APPARATUS AND METHOD FOR DECIDING TRAVELING DIRECTION OF NAVIGATION SYSTEM

(76) Inventor: Jeong Su JEON, Icheon-Shi (KR)

Correspondence Address: IPLA P.A., 3580 WILSHIRE BLVD., 17TH FLOOR, LOS ANGELES, CA, 90010, US

(21) Appl. No.: 11/424,853

(22) Filed: Jun. 16, 2006

(30) Foreign Application Priority Data
Jul. 26, 2005 (KR) 10-2005-0067907

(51) Int. Cl. G01C 21/30

(52) U.S. Cl. 701/209

(57) ABSTRACT

An apparatus and method for deciding a traveling direction of a navigation system is provided. The apparatus includes: an input unit for receiving longitude and latitude coordinates, a kind of a road, and number of lanes; a traveling direction processor for, when it is determined using the point information received through the input unit that a current road where a self vehicle exists and a front road are of the same kind and lane, deciding the traveling direction to be a straight advance and, when it is determined that the current road and the front road are of a mutually different kind and lane, deciding the traveling direction to be a left/right turn and the straight advance using a convex hull algorithm; and an output unit for displaying on a screen whether the road is in any traveling direction of the left/right turn and the straight advance.

### BACKGROUND OF THE INVENTION

1. Field of the Invention

The present invention relates to a navigation system, and more particularly, to an apparatus and method for deciding a traveling direction of a navigation system, in which, when a navigation path search is performed, it is decided to be a left/right turn or a straight advance depending on a kind of a road where a self vehicle is positioned and number of lanes, and it is clearly displayed whether the left/right turn or the straight advance is performed for a front road, thereby allowing a user's stable traveling.

2. Description of the Related Art

In a conventional navigation path search method, a left/right turn and a straight advance are decided using a convex hull algorithm, depending on a relation between roads connected with a vehicle position.

The convex hull algorithm is one of the best 2-phase methods developed by Golden and Stewart, and a path between two points is obtained using the convex hull algorithm.

In the convex hull algorithm based on assumption that there exist three points (node 1, node 2 (intersection) and node 3), a self vehicle is positioned on a road connecting the nodes 1 and 2, and the nodes 1 and 2 are at an angle of “a” and the nodes 1 and 3 are at an angle of “b” on the basis of the node 1, when a relation of a >b is satisfied, a direction to the node 2 centering on the node 1 is a left turn and, when a relation of a <b is satisfied, the direction to the node 2 is a right turn.

In a decision using an area of a triangle formed by the three points so as to facilitate to calculate an azimuth angle, when coordinates of the nodes 1, 2, and 3 are expressed as (x1, y1), (x2, y2), and (x3, y3), the node 3 can be decided whether to be in any direction on the basis of the node 1.
AREA=((x1*y2−x3*y2)+(y1*x3−x1*y3) +(x2*y3−x2*y1))/2

If the AREA has a minus value, the node 3 can be determined to be on the right side of the node 1 and, on the contrary, it can be determined to be on the left side of the node 1.

As described above, in the conventional navigation path search, the traveling direction is decided through a simple comparison of coordinates or angles between two points. Therefore, in the conventional decision of the traveling direction, even though the front road is recognized to be in the straight advance at a user's sight, if the front road is not positioned within a predetermined angle from the traveling direction, the navigation system recognizes the traveling direction to be the left turn or the right turn, thereby frequently causing a phenomenon in which a displayed path not matched with a real path seen with naked eyes, and becoming one of causes of perplexing a driver and deteriorating a safe driving.

### SUMMARY OF THE INVENTION

Accordingly, the present invention is directed to an apparatus and method for deciding a traveling direction of a navigation system that substantially overcome one or more of the limitations and disadvantages of the conventional art.

One object of the present invention is to provide an apparatus and method for deciding a traveling direction of a navigation system in which, when a navigation path search is performed, not only a simple comparison based on positions between roads but also a kind of a road where a self vehicle is positioned and number of lanes are considered to decide the traveling direction to be a left/right turn or a straight advance for a front road and displaying the decided direction for a user.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an apparatus for deciding a traveling direction of a navigation system, the apparatus including: an input unit for receiving longitude and latitude coordinates, a kind of a road, and number of lanes, as information on a point connected to a link being currently under search, information on a point of a three or more branched intersection, and information on a point of each link connected to the interconnection; a traveling direction processor for, when it is determined using the point information received through the input unit that a current road where a self vehicle exists and a front road are of the same kind and lane, deciding the traveling direction to be a straight advance and, when it is determined that the current road where the self vehicle exists and the front road are of a mutually different kind and lane, deciding the traveling direction to be a left/right turn and the straight advance using a convex hull algorithm; and an output unit for displaying on a screen whether the road connected to the link being currently under search is in any traveling direction of the left/right turn and the straight advance.

In another aspect of the present invention, there is provided a method for deciding a traveling direction of a navigation system, the method including the steps of: performing a path search in the navigation system; determining whether or not a current road is the same in kind as a front road through comparison; if it is determined that the current road is the same in kind as the front road, determining whether or not the current road is the same in lane as the front road through comparison; if it is determined that the current road is different in kind from the front road, deciding the traveling direction to be a left/right turn, using a convex hull algorithm applied; if it is determined that the current road is the same in lane as the front road, deciding the traveling direction to be a straight advance; if it is determined that the current road is different in lane from the front road, deciding the traveling direction to be the left/right turn, using the convex hull algorithm applied; and displaying the decided traveling direction on a screen.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a block diagram illustrating an apparatus for deciding a traveling direction of a navigation system according to a preferred embodiment of the present invention; and

FIG. 2 is a flowchart illustrating a method for deciding a traveling direction of a navigation system according to a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

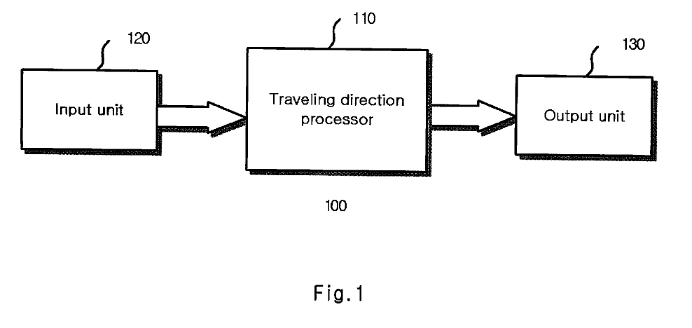

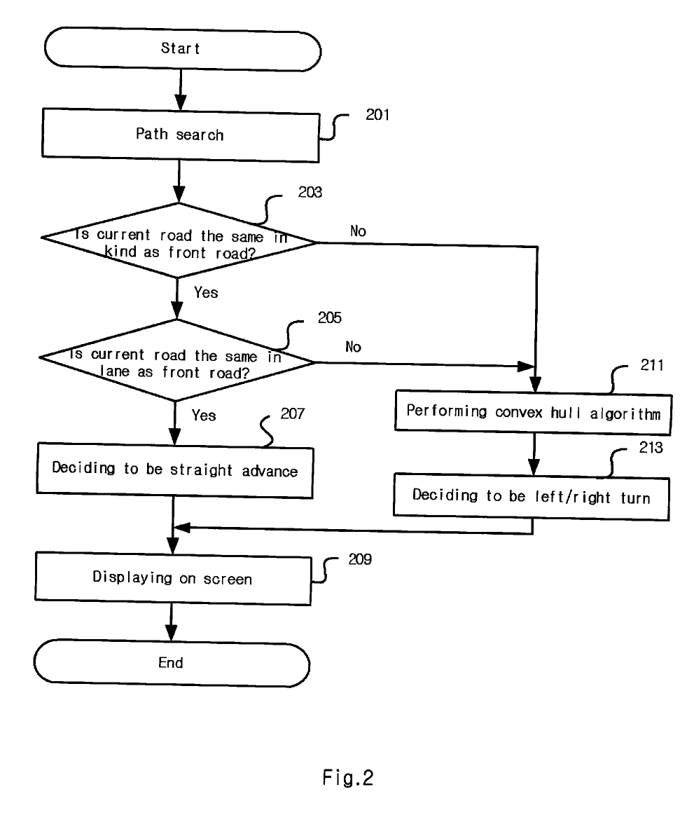

FIG. 1 is a block diagram illustrating an apparatus for deciding a traveling direction of a navigation system according to a preferred embodiment of the present invention, and FIG. 2 is a flowchart illustrating a method for deciding the traveling direction of the navigation system according to a preferred embodiment of the present invention.

Hereinafter, the apparatus and method for deciding the traveling direction of the navigation system according to the present invention will be in detail described.

As shown in FIG. 1, the inventive deciding apparatus 100 includes an input unit 120, a traveling direction processor 110, and an output unit 130.

The input unit 120 receives longitude and latitude coordinates, a kind of a road, and number of lanes, as information on a point connected to a link being currently under search, information on a point of a three or more branched intersection, and information on a point of each link connected to the interconnection.

The point information of each link is received from a server or its relating database of a contents provider (CP) providing corresponding information through a wire/wireless communication network. Therefore, the input unit 120 can be a wire/wireless unit for communicating with a remote database.

The input unit 120 can be also a navigation key input unit (not shown) for a user's key press for data change or addition.

In case where it is determined using the point information received through the input unit 120 that a current road where a self vehicle exists and a front road are of the same kind and lane, the traveling direction processor 110 decides the traveling direction to be a straight advance. In case where it is determined that the current road and the front road are of a mutually different kind and lane, the traveling direction processor 110 decides the traveling direction to be a left/right turn and the straight advance, using a convex hull algorithm.

The output unit 130 displays on a screen whether the road connected to the link being currently under search is in any traveling direction. The output unit 130 includes an image processor and a display device driver for displaying a corresponding traveling direction on a display device such as a liquid crystal display (LCD).

The method for deciding the traveling direction in the deciding apparatus 100 according to the present invention will be in detail with reference to FIG. 2.

In the inventive deciding method, in Step 201 of FIG. 2, an operation for the navigation path search is performed through the user's key press.

Before the path search of the navigation system, in the deciding apparatus 100, the input unit 120 receives the longitude and latitude coordinates, the kind of the road, and the number of the lanes, as the information on the point connected to the link being currently under search, the information on the point of the three or more branched intersection, and the information on the point of each link connected to the interconnection.

After execution of the path search of the navigation system in the Step 201, in Step 203, the traveling direction processor 110 determines through comparison whether or not the current road is the same in kind as the front road. If the current road is determined to be the same in kind as the front road in the Step 203, in Step 205, it is determined through comparison whether or not the current road is the same in lane as the front road.

If the current road is determined in the Step 205 to be different in lane from the front road, in Step 211, the traveling direction processor 110 decides the traveling direction to be the left/right turn using the convex hull algorithm applied. If the current road is determined to be the same in lane as the front road, in Step 207, the traveling direction processor 110 decides the traveling direction to be the straight advance.

If the current road is determined in the Step 205 to be different in lane from the front road, in Step 207, the traveling direction processor 110 decides the traveling direction to be the left/right turn using the applied convex hull algorithm.

Accordingly, the traveling direction processor 110 displays the decided traveling direction on the screen depending on the decision of the traveling direction of the Steps 207 and 211, thereby accurately deciding the traveling direction of the navigation system and clearly displaying the decided direction on a path.

As described above, the present invention has an effect in that, when the navigation path search is performed, the left/right turn or the straight advance are decided depending on the kind of the road where the self vehicle is positioned and the number of the lanes, and it is clearly displayed whether the left/right turn or the straight advance is performed for the front road, thereby allowing the user's stable traveling.

Further, the present invention has an effect in that, in the navigation path search, the decided traveling direction can be displayed as if the user sees a substantial road, thereby allowing the driver to be previously well aware of a substantial circumstance on the road and therefore, allowing the safe driving.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An apparatus for deciding a traveling direction of a navigation system, the apparatus comprising:
an input unit for receiving longitude and latitude coordinates, a kind of a road, and number of lanes, as information on a point connected to a link being currently under search, information on a point of a three or more branched intersection, and information on a point of each link connected to the interconnection;
a traveling direction processor for, when it is determined using the point information received through the input unit that a current road where a self vehicle exists and a front road are of the same kind and lane, deciding the traveling direction to be a straight advance and, when it is determined that the current road where the self vehicle exists and the front road are of a mutually different kind and lane, deciding the traveling direction to be a left/right turn and the straight advance using a convex hull algorithm; and
an output unit for displaying on a screen whether the road connected to the link being currently under search is in any traveling direction of the left/right turn and the straight advance.

2. A method for deciding a traveling direction of a navigation system, the method comprising the steps of:
performing a path search in the navigation system;
determining whether or not a current road is the same in kind as a front road through comparison;
if it is determined that the current road is the same in kind as the front road, determining whether or not the current road is the same in lane as the front road through comparison;
if it is determined that the current road is different in kind from the front road, deciding the traveling direction to be a left/right turn, using a convex hull algorithm applied;
if it is determined that the current road is the same in lane as the front road, deciding the traveling direction to be a straight advance;
if it is determined that the current road is different in lane from the front road, deciding the traveling direction to be the left/right turn, using the convex hull algorithm applied; and
displaying the decided traveling direction on a screen.

3. The method according to claim 2, further comprising the step of: before the performing of the path search in the navigation system, receiving longitude and latitude coordinates, a kind of the road, and number of the lanes, as information on a point connected to a link being currently under search, information on a point of a three or more branched intersection, and information on a point of each link connected to the interconnection.
